(19) United States
(12) Patent Application Publication
(10) Pub. No.: US 2007/0150668 A1
(43) Pub. Date: Jun. 28, 2007

(54) MULTI-PATH ACCESSIBLE SEMICONDUCTOR MEMORY DEVICE

(75) Inventors: Kyoung-Hwan KWON, Seoul (KR); Dong-Il SEO, Gyeonggi-do (KR); Ho-Cheol LEE, Gyeonggi-do (KR); Han-Gu SOHN, Gyeonggi-do (KR); Yun-Hee SHIN, Gyeonggi-do (KR)

Correspondence Address: MARGER JOHNSON & MCCOLLOM, P.C., 210 SW MORRISON STREET, SUITE 400, PORTLAND, OR, 97204, US

(73) Assignee: SAMSUNG ELECTRONICS CO., LTD., Gyeonggi-Do (KR)

(21) Appl. No.: 11/548,603

(22) Filed: Oct. 11, 2006

(30) Foreign Application Priority Data
Dec. 22, 2005 (KR) 2005-127532

(51) Int. Cl. G06F 12/00

(52) U.S. Cl. 711/149

(57) ABSTRACT

A semiconductor memory device includes ports, data line pairs, where each port associated with one of the data line pairs, sets of address lines, where each port associated with one of the sets of address lines, a shared memory region of a memory cell array, where the shared memory region accessible through the ports, an access controller coupled to the ports and configured to generate an access selection signal in response to a plurality of control signals received through the ports, and an access router coupled to the shared memory region, the data line pairs, and the sets of address lines, the access router configured to selectively couple one of the sets of address lines and one of the data line pairs to the shared memory region in response to the access selection signal.

### CROSS-REFERENCE TO RELATED APPLICATIONS

This application claims priority from Korean Patent Application No. 10-2005-127532, filed on 22 Dec. 2005, the content of which is incorporated by reference in its entirety for all purposes.

### BACKGROUND OF THE INVENTION

1. Technical Field

This disclosure relates to semiconductor memory devices, and more particularly, to multi-path accessible semiconductor memory devices for use in portable communication devices.

2. Description of The Related Art

In general, a semiconductor memory device having multiple access ports is called a multi port memory. In particular, a memory device having two access ports is called a dual port memory. A typical dual port memory, well known to those skilled in the field is an image processing video memory having a RAM (Random Access Memory) port to allow access in a random sequence and an SAM (Serial Access Memory) port to allow access only by a serial sequence.

In order to differentiate a dynamic random access memory having multiple access ports from the multi port memory having a SAM port as described above, the dynamic random access memory having multiple access ports and capable of to reading or writing to a shared memory region through multiple access ports, the dynamic random access memory will be referred to as a multi-path accessible semiconductor memory device. In contrast, the above-mentioned video memory did not have two RAM ports.

The use of electronic systems has become ubiquitous in current societies. In the development of handheld electronic systems, such as a handheld phone or PDA (Personal Digital Assistant), etc., manufacturers have used multi processor systems employing multiple processors as shown in FIG. 1 to obtain high speed functionality or smooth operation in these systems.

Referring to FIG. 1, a first processor 10 is connected to a second processor 12 through a connection line L10. A NOR memory 14 and a DRAM 16 are connected to the first processor 10 through determined buses B1-B3. A DRAM 18 and a NAND memory 20 are connected to the second processor 12 through determined buses B4-B6. The first processor 10 may have a MODEM function to perform a modulation and/or demodulation of a communication signal. The second processor 12 may have an application function to process communication data or provide a game or other entertainment to a user, etc. The NOR memory 14 includes a NOR structure in the cell array configuration. The NAND memory 20 includes a NAND structure. Both are nonvolatile memories including transistor memory cells that have floating gates, in order to store data that must not be lost when power is removed. For example, such data may include firmware or other code for a handheld instruments or data such as configuration data. The DRAMs function as main memories of processing data of processors.

However, in a multi processor system as shown in FIG. 1, DRAMs are each allocated to each processor and accessed through relatively low speed interfaces, such as UART (Universal Asynchronous Receiver/Transmitter), SPI (Serial Peripheral Interface) and SRAM (Static Random Access Memory). Thus, it is difficult to obtain a satisfactory data transmission speed and size complexity is increased. Furthermore, there is an increased cost in configuring memories.

In FIG. 2, one DRAM 117 is connected with first and second processors 10 and 12 through buses B1 and B2, in contrast to the system of FIG. 1. In the structure of multi processor system of FIG. 2, in order to enable access by multiple processors to one DRAM 117 through two paths, two ports are required in the DRAM to be connected to corresponding buses B1 and B2. However, a conventional DRAM includes only a single port PO as shown in FIG. 3.

Referring to FIG. 3 illustrating a conventional structure of a DRAM, a memory cell array 1 includes first to fourth banks 3, 4, 5 and 6 each having a row decoder RD and a column decoder CD. An upper input/output sense amplifier and driver 13 are operatively coupled to first bank 3 or third bank 5 through a multiplexer 11 or 25, respectively. A lower input/output sense amplifier and driver 15 are operatively coupled to a second bank 4 or fourth bank 6 through a multiplexer 13 or 26, respectively.

For example, when a memory cell within the first bank 3 is selected and data stored in the selected memory cell is read, output operation of the read data is described as follows. First, a selected word line is activated. Then, data of a memory cell sensed and amplified by a bit line sense amplifier is transferred to a local input/output line pair 9 by an activation of corresponding column selection line CSL. Data transferred to the local input/output line pair 9 is transferred to a global input/output line pair 10 by a switching operation of first multiplexer 321. The second multiplexer 11, coupled to a global input/output line pair 10 transfers data of the global input/output line pair 10 to the upper input/output sense amplifier and driver 13. Data again sensed and amplified by the input/output sense amplifier and driver 13 is output to a data output line L5 through a path part 27.

In another example, when data stored in a memory cell of the fourth bank 6 is read, the data is output to an output terminal DQ, sequentially passing through first multiplexer 324, second multiplexer 26, lower input/output sense amplifier and driver 15, path part 27 and data output line L5. Thus, the DRAM 1 of FIG. 3 has a structure such that that two banks share an input/output sense amplifier and driver, and the DRAM 1 includes a single port PO through which data may be input or output. The DRAM 1 of FIG. 3 can be used in the system of FIG. 1, but it is di multi processor system referred to in FIG. 2 by the structure of memory bank or port.

In an attempt to use memory appropriate for the multi processor system referred to in FIG. 2, a conventional memory based on a configuration illustrated as part of FIG. 4 in which a shared memory region of the memory can be accessed by multiple processors has been developed. Referring to FIG. 4 illustrating a multi processor system 50, a memory array 435 includes first, second and third portions. The first portion 433 of the memory array 435 is accessible only by a first processor 470 through a port 437. The second portion 431 is accessible only by a second processor 480 through a port 438. The third portion 432 is accessible by both the first and second processors 470 and 480. The size of first and second portions 433 and 431 of the memory array 435 can be variously changed according to of the accesses the first and second processors 470 and 480 during operation. The memory array 435 may be a memory type or disk storage type.

However, in order to implement the third portion 432, shared by the first and second processors 470 and 480 within the memory array 435 in the structure of DRAM, several difficulties arise. For example, it is difficult to layout the memory regions and input/output sense amplifiers within the memory array 435, and implement a proper read/write path control technique, to implement the shared portion. Furthermore, because a swing level of data output through respective ports is directly linked with a data transmission speed, a specific control is required over the swing level.

Accordingly, there remains a need for an improved apparatus and method to share a shared memory region allocated within a DRAM memory cell array in a multi processor system having at least two processors.

### SUMMARY

A semiconductor memory device includes ports, data line pairs, where each port associated with one of the data line pairs, sets of address lines, where each port associated with one of the sets of address lines, a shared memory region of a memory cell array, where the shared memory region accessible through the ports, an access controller coupled to the ports and configured to generate an access selection signal in response to a plurality of control signals received through the ports, and an access router coupled to the shared memory region, the data line pairs, and the sets of address lines, the access router configured to selectively couple one of the sets of address lines and one of the data line pairs to the shared memory region in response to the access selection signal.

Another embodiment includes a method of operating a semiconductor memory device including receiving a plurality of addresses through a plurality of ports, each address associated with an access through an associated port, generating an access selection signal in response to a plurality of control signals received through the ports, selecting an address from among the addresses for access to a shared memory region in response to the access selection signal, forming a data input/output path between a port associated with the selected address and the shared memory region in response to the access selection signal, and accessing data in the shared memory region through the data input/output path.

### BRIEF DESCRIPTION OF THE DRAWINGS

The above and other features of embodiments will become readily apparent from the description that follows, with reference to the attached drawings in which:

FIG. 1 is a block diagram of a conventional multi processor system for use in a portable communication device;

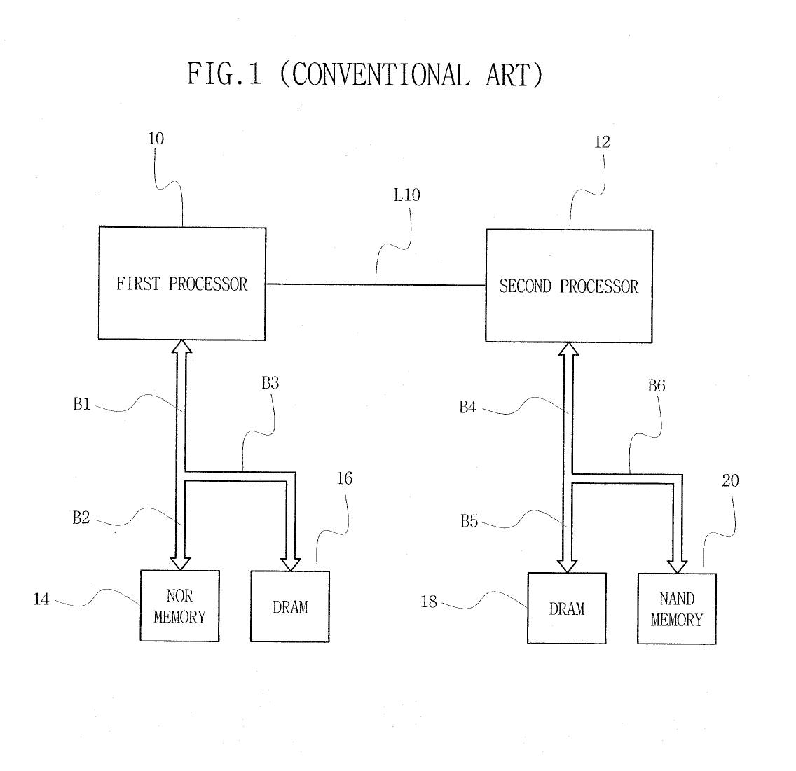

FIG. 2 is a block diagram illustrating an example of conventional multi processor system employing a memory that may be adaptable according to an embodiment;

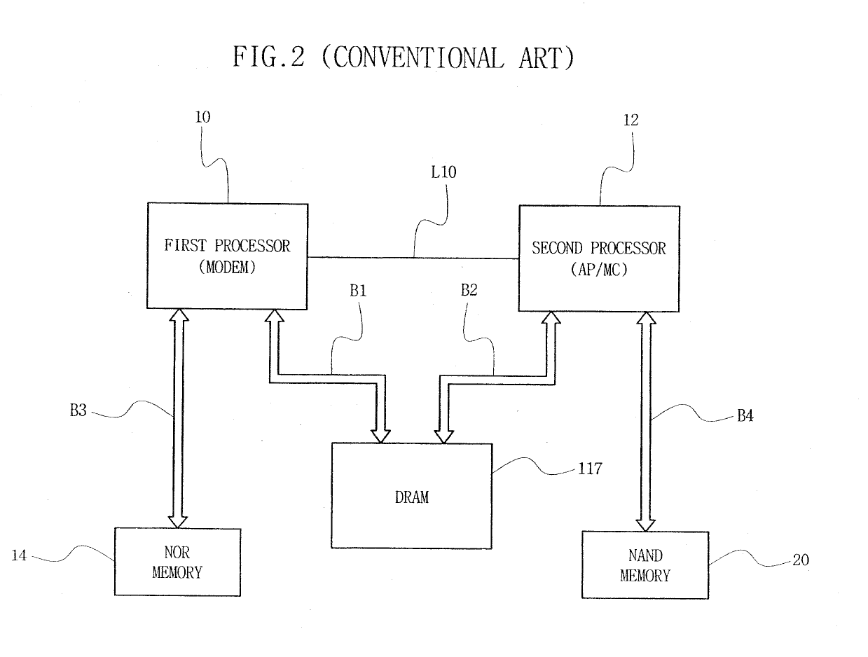

FIG. 3 is a block diagram illustrating an internal structure of a conventional memory cell array of DRAM;

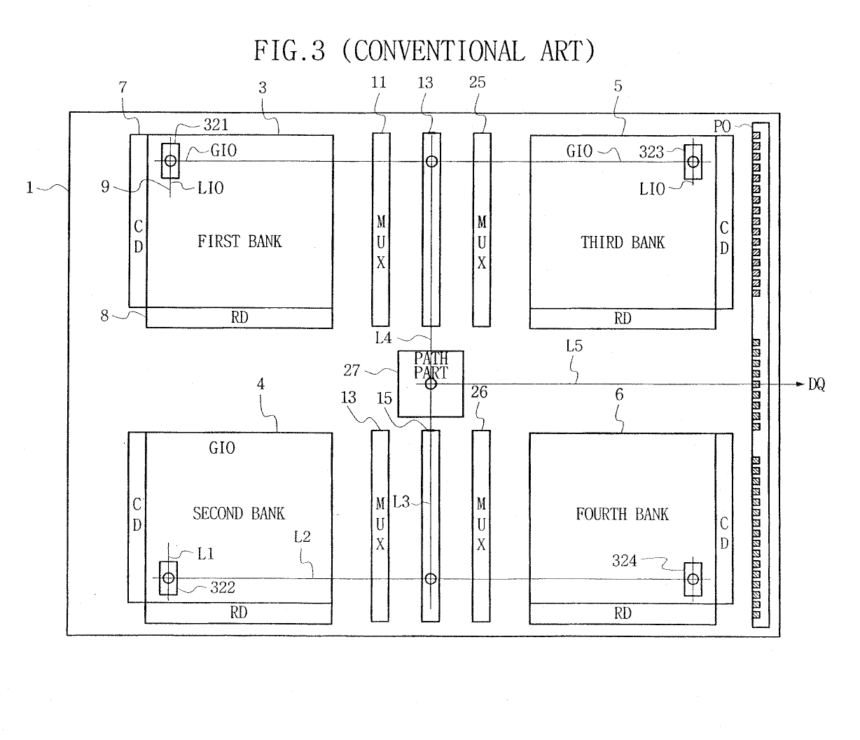

FIG. 4 is a block diagram illustrating conventional memory array portions of a multi processor system;

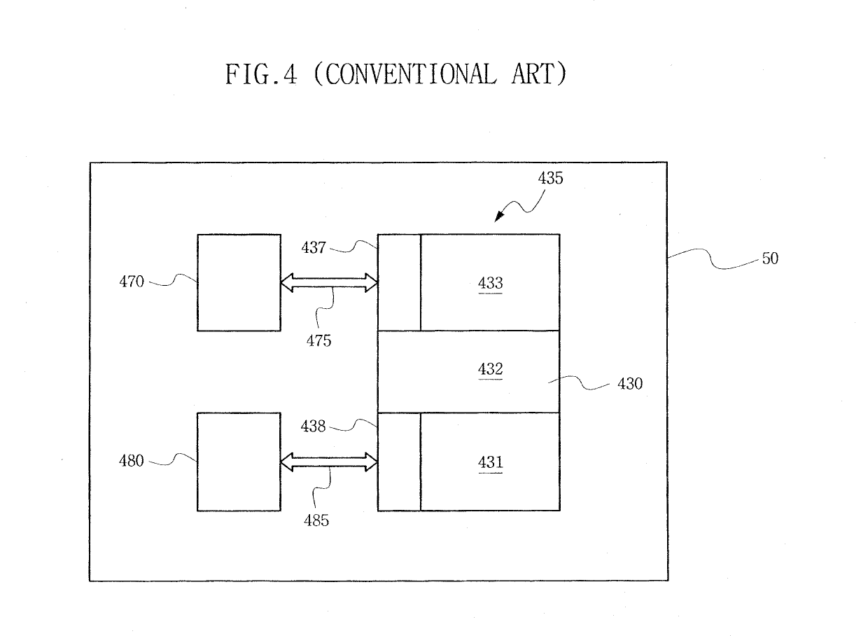

FIG. 5 is a block diagram of multi processor system having a multi path accessible DRAM according to embodiments;

FIG. 6 is a block diagram illustrating a layout of memory regions and ports in a multi path accessible DRAM shown in FIG. 5;

FIG. 7 is a block diagram illustrating in detail a multi path accessible DRAM of FIG. 6;

FIG. 8 is a block diagram illustrating in detail a circuit related to a datan access of shared bank shown in FIG. 7;

FIG. 9 is a circuit diagram illustrating in detail an embodiment of path deciding part shown in FIGS. 7 and 8;

FIG. 10 is a circuit diagram illustrating in detail an address multiplexer shown in FIGS. 7 and 8;

FIG. 11 is a circuit diagram illustrating in detail a second multiplexer shown in FIGS. 7 and 8;

FIG. 12 is a block diagram illustrating read and write paths shown in FIG. 8;

FIG. 13 is a block diagram illustrating a fuse option for a power source level selection per port according to embodiments;

FIG. 14 is a block diagram illustrating various control options for a power source level selection per port according to another embodiment similar to FIG. 13; and

FIG. 15 is a graph for various levels of power sources applied per port in a DRAM according to an embodiment.

### DETAILED DESCRIPTION

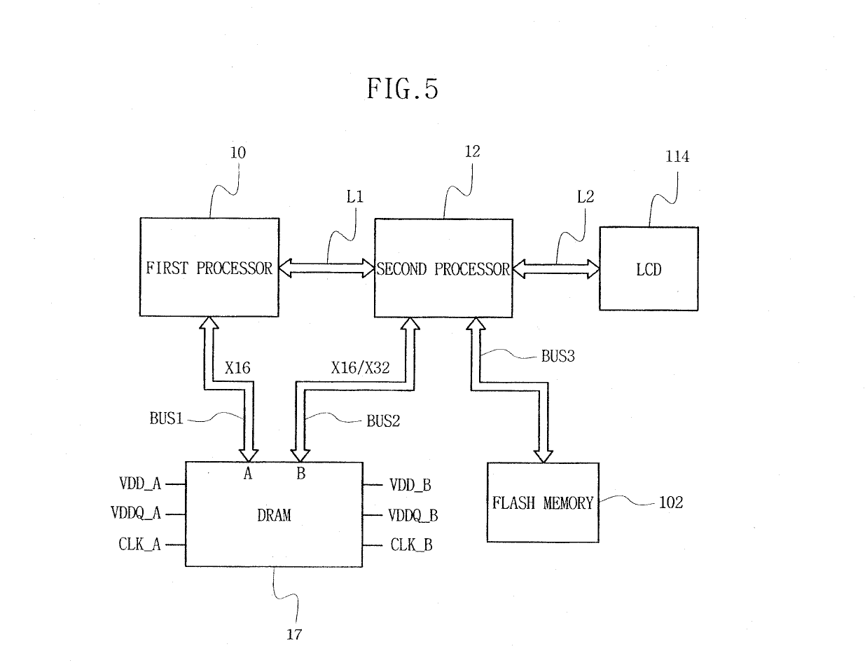

Embodiments are more fully described in detail with reference to FIGS. 5 to 15. However, embodiments many take different forms and should not be construed as being limited to the embodiments set forth herein. Rather, these embodiments are provided so that this disclosure is thorough and complete, and will enable one skilled in the art.

In the following description, other examples, published methods, procedures, general dynamic random access memory and circuits will not be described in detail so as not to obscure the embodiments.

In addition, although descriptive terms including letters such as A and B, and ordinal numbers such as first and second have been used, one skilled in the art will understand that the labeling is used solely to aid in discussion of the embodiments and not to imply an order, sequence, or number.

A multi-path accessible semiconductor memory device for use in a multi processor system according to embodiments will be described referring to the accompanied drawings, as follows.

FIG. 5 is a block diagram of multi processor system having a multi path accessible DRAM according to an embodiment. With reference to FIG. 5, a portable communication system may include a first processor 10 for performing a first determined task, a second processor 12 for performing a second determined task, and a dynamic random access memory (DRAM) 17 having a memory region within a memory cell array accessible by the first and second processors 10 and 20. The portable communication system may include a flash memory 102 connected to the second processor 12 through a bus BUS3, and a display part 114 connected to the second processor 12 through a connection line L2. In this particular embodiment, display part 114 is a liquid crystal display (LCD), however, one skilled in the art will understand that display part 114 may include other types of displays.

The DRAM 17 shown in FIG. 5 may include independent ports A and B. Port A may also be referred to as a first port and port B may be referred to as a second port. The first port is connected to the first processor 10 through a system bus BUS1. The second port is connected to the second processor 12 through a system bus BUS2. The first processor 10 may include one or more functions such as a MODEM function, for example, to performing a modulation and/or demodulation of communication signal, or a base band processing function, as a processing task. Similarly, the second processor 12 may include one or more functions such as an application function of processing communication data or providing entertainment such as a game or a movie, etc. to a user as a processing task.

Although no particular bus width is required, when the system bus BUS1 is 16 bits, the system bus BUS2 may be 16 bits or 32 bits (x16,x32).

The flash memory 102 is a nonvolatile memory. The flash memory 102 may include MOS (Metal Oxide Semiconductor) transistor structures. Such transistor structures may form the cell array of the flash memory 102. Examples of such structures include a NOR structure and a NAND structure, both of which include floating gates as part of memory cells. The flash memory 102 is provided to store data that should be maintained even during a power loss. For example, specific code and data of portable instruments may be stored in the flash memory 102.

As shown in FIG. 5, the DRAM 17 having a dual port may be used to store data and commands for use by processors 10 and 12. And the DRAM 17 may receive operating power source voltages VDD_A, VDD_B, VDDQ_A and VDDQ_B, and clocks CLK_A and CLK_B. Each of port A and port B may be associated with a set of power source voltages and clocks. As a result processing tasks of the processors 10 and 12 may be performed more smoothly

The system of FIG. 5 may be a portable computing device or portable communication device. Such devices may include a mobile communication device, such as a cellular phone, a bi-directional radio communication system, a single directional pager, a bi-directional pager, a personal communication system, a portable computer, or the like.

In the system of FIG. 5, the number of processors may be increased to three or more. The processors of the system may be a microprocessor, CPU, digital signal processor, micro controller, reduced-command set computer, complex command set computer, or the like. Any number of processors may be used within the system. Furthermore, the processors may be any combination of types, models, styles, varieties, etc.

An embodiment of a layout of the shared memory region in DRAM 17 shown in FIG. 5 and an access operation by the processors 10 and 12 will be described in detail referring to the drawings illustrating the interior of memory device.

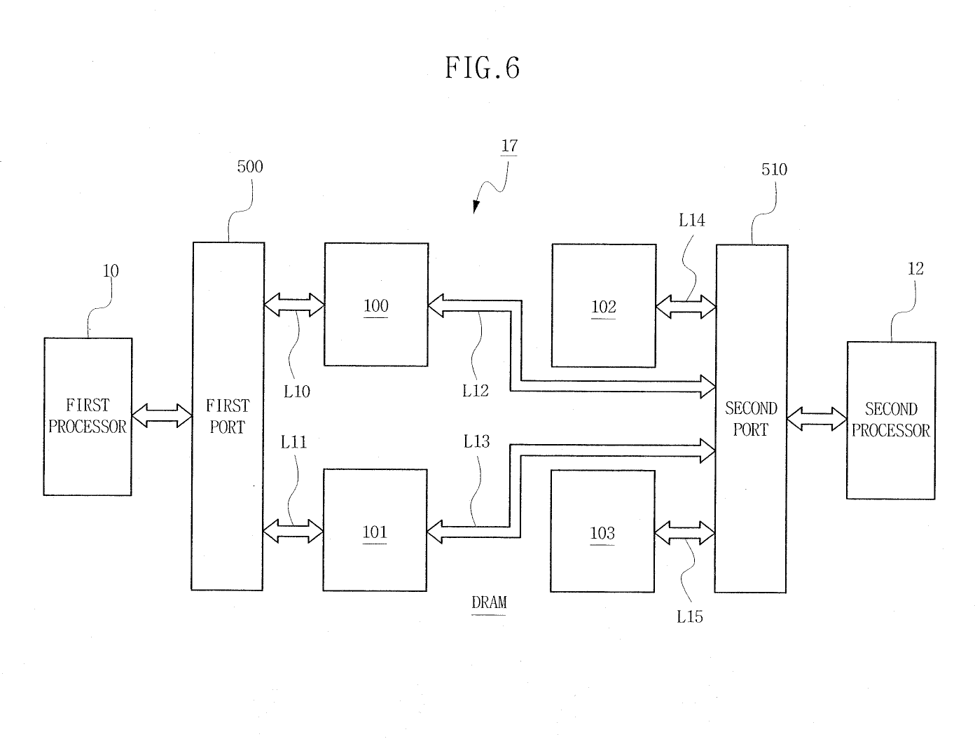

FIG. 6 is a block diagram illustrating a layout of memory regions and ports in a multi path accessible DRAM shown in FIG. 5. As shown in FIG. 6, four memory regions 100-103 are disposed within a memory cell array, and first and second memory regions 100 and 101 are accessed by all of the first and second processors 10 and 12 through respective first and second ports 500 and 510. The first and second memory regions 100 and 101 are shared memory regions, and third and fourth memory regions 102 and 103 are private memory regions accessible only by the second processor 12.

The four memory regions 100-103 may be individually configured as a bank unit of DRAM. One bank may have a storage capacity of 64 Mbit, 128 Mbit, 256 Mbit, 512 Mbit, or 1024 Mbit, for example.

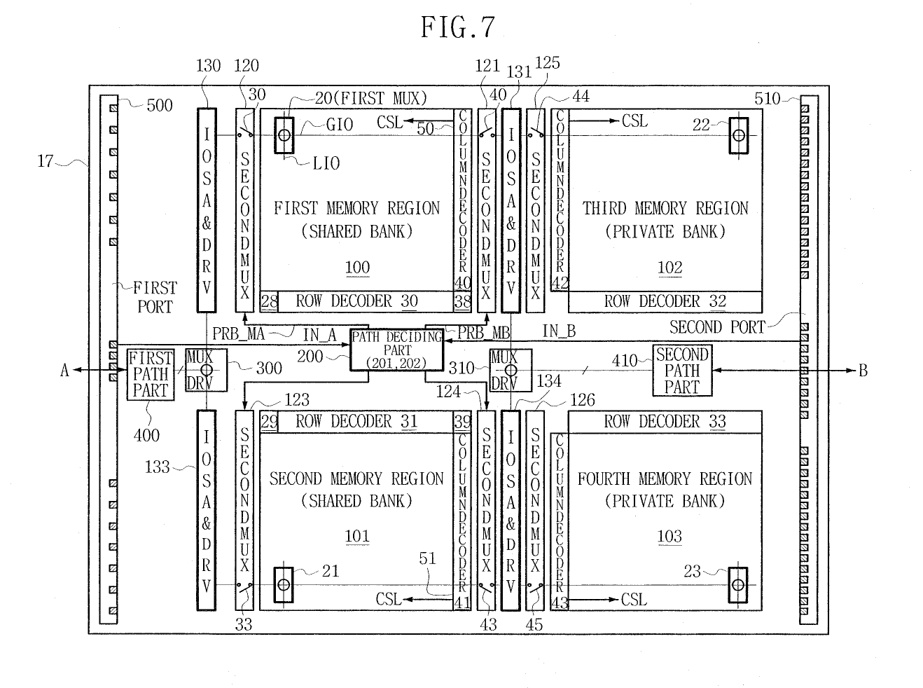

In FIG. 6, for example, when the first processor 10 accesses the first memory region 100 through the first port 50, the second processor 12 may access to one memory region of second, third and fourth memory regions 101-103 through the second port 510, substantially simultaneously. Such multi-path access operation is not shown in FIG. 6, but may be performed by an access path forming part basically including an access controller 200 shown in FIG. 7.

FIG. 7 is a block diagram illustrating in detail a multi path accessible DRAM of FIG. 6. For example, the four memory regions 100-103 are disposed symmetrically, and two regions of the four memory regions are allocated as shared memory regions all accessible by the first and second processors 10 and 12, and the other two regions are allocated as private memory regions accessible only by the second processor 12.

In an example for first memory region 100 accessible by both the first and second processors 10 and 12, a global input/output line GIO within the first memory region 100 may be selectively coupled to one of the first and second ports respectively coupled to buses of the first and second processors. Such selective coupling may be performed by a control operation of the access controller 200.

The access controller 200, contained in the access path forming part, generates access selection signals PRB_MA and PRB_MB for forming a datan access path between a selected port of the first and second ports and the first memory region 100. The access selection signals PRB_MA and PRB_MB are generated in response to external signals IN_A and IN_B applied from the first and second processors 10 and 12.

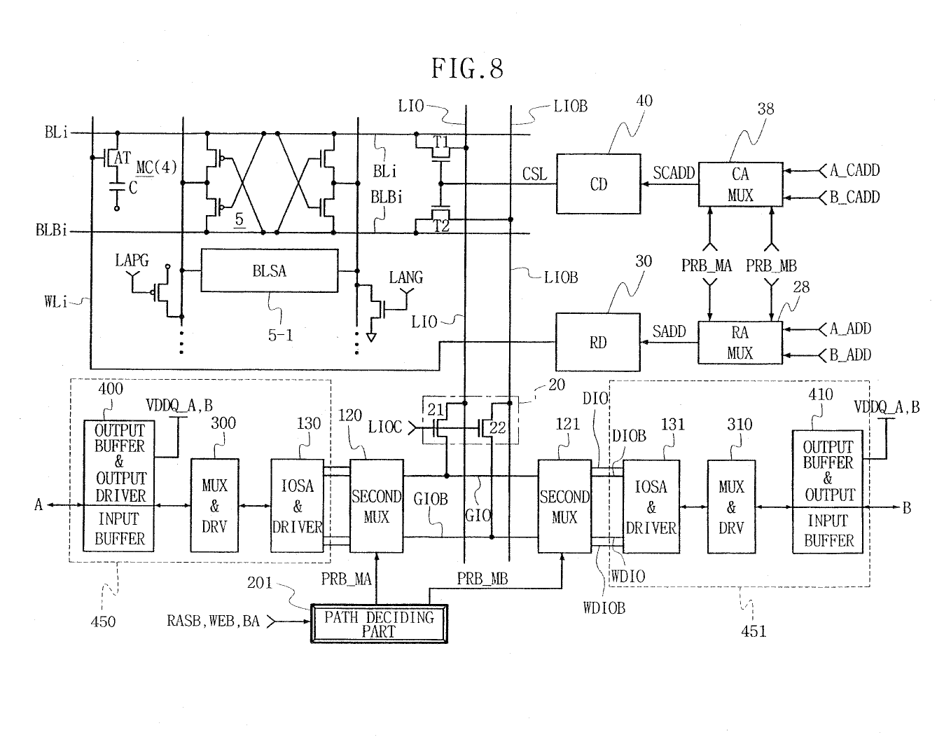

With reference to FIG. 7 and FIG. 8, illustrating a block diagram of circuits related to a datan access of a shared bank shown in FIG. 7, the access path forming part will be described in detail as follows.

The access controller 200 of FIG. 7, for logically combining external signals and generating an access selection signal, includes two of the path deciding part 201 as shown in FIG. 8. Although only one path deciding part 201 is illustrated in FIG. 8, a second path deciding part 201 may be included within the access controller 200 in order to control access to another shared bank, such as the second memory region 101 shown in FIG. 7.

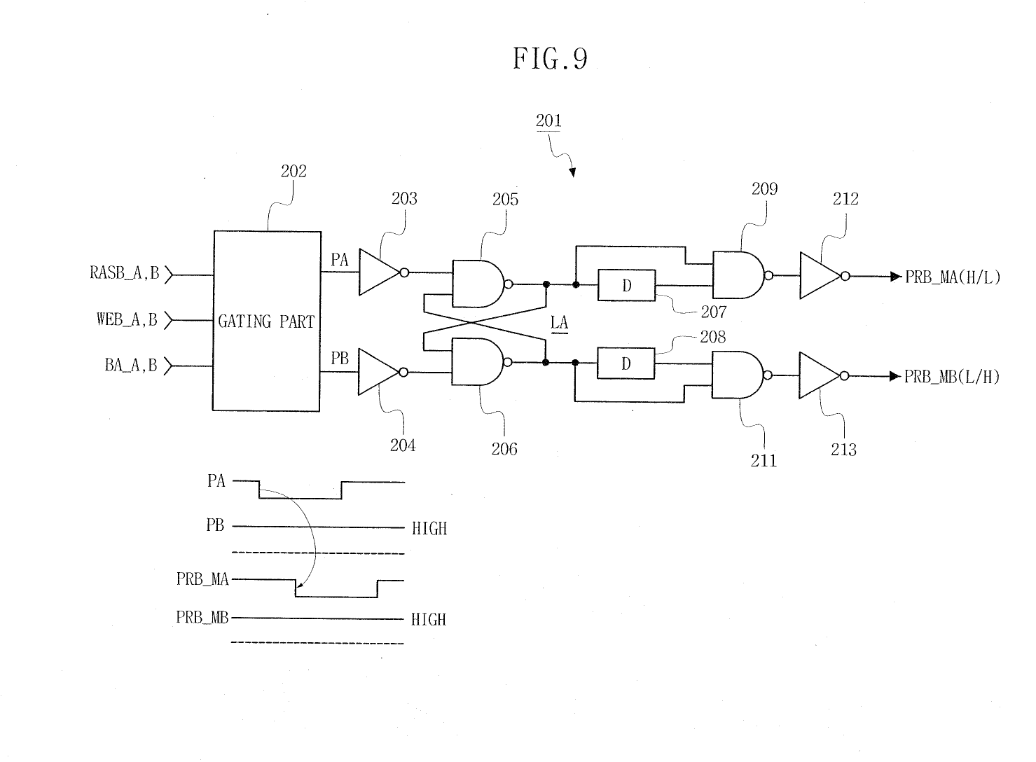

The circuit of a path deciding part 201 may be realized as shown in FIG. 9. The access controller 200 is a functional block of the access path forming part. The external signals may contain a row address strobe signal RASB, write enable signal WEB, and bank selection address BA respectively applied through the first and second ports 500 and 510, as shown in FIG. 7.

As shown in FIGS. 7 and 8, the access path forming part may include row and column address multiplexers 28 and 38, first and second global multiplexers 120 and 121, and an input/output related path part.

The row and column address multiplexer 28, 38 select one row and column address (A_ADD and A_CADD for example) from row and column addresses A_ADD, B_ADD, A_CADD and B_CADD respectively applied through the first and second ports 500 and 510. The selection is made in response to the access selection signals PRB_MA and PRB_MB. The selected row address is applied to a row decoder 30 and the selected column address is applied to a column decoder 40, both of which are coupled to the shared memory region 100.

The first and second global multiplexers 120 and 121 are coupled to a global input/output line pair GIO, GIOB of the shared memory region and a respective first data input/output line pair DIO, DIOB and write data input/output line pair WDIO, WDIOB. The selection is made in response to the access selection signal PRB_MA and PRB_MB for the first and second global multiplexers 120 and 121, respectively.

An access router may include the first and second global multiplexers 120 and 121, and the row and column address multiplexer 28 and 38. Thus, in response to the access selection signals PRB_MA and PRB_MB, the access router selects an address and forms a data input/output path between the global input/output line pair and the selected data input/output line pair.

The input/output related path part includes first input/output related circuitry 450 including a input/output sense amplifier and driver 130, a multiplexer and driver 300, and a input/output buffer and driver 400 coupled between the first global multiplexer 120 and the first port 500. Similarly, the input/output related path part includes second input/output related circuitry 451 including a input/output sense amplifier and driver 131, a multiplexer and driver 310, and a input/output buffer and driver 410 coupled between the second global multiplexer 121 and the second port 510.

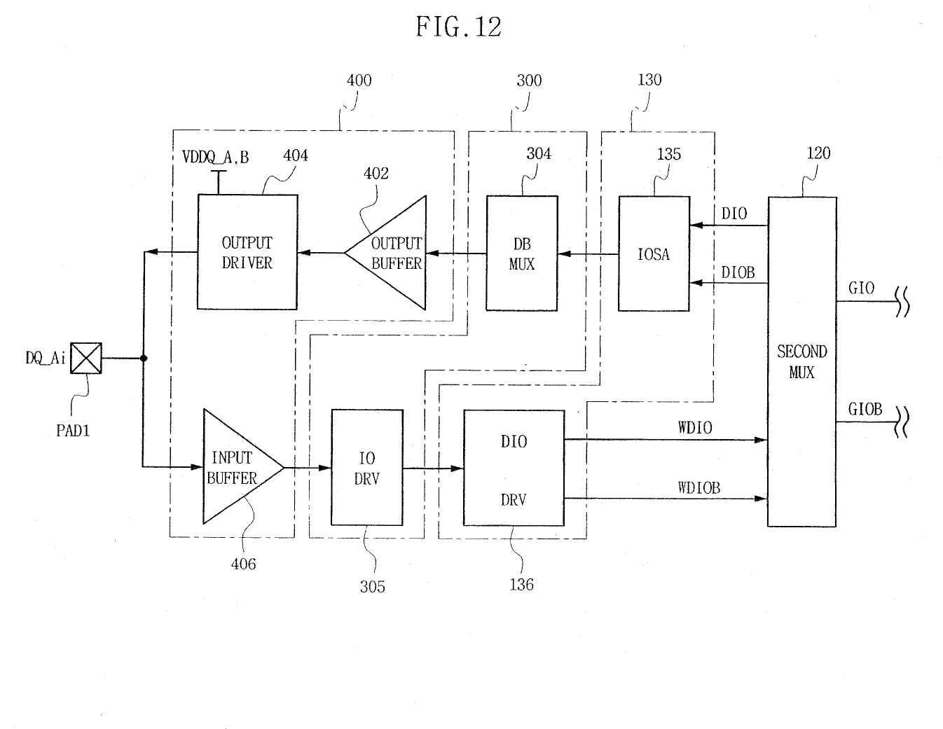

The first input/output related circuitry 450 may include a data output path circuit and a data input path circuit as shown in FIG. 12 illustrating in detail read and write paths shown in FIG. 8.

Referring to FIG. 12, the data output path circuit may include an input/output sense amplifier 135 coupled to the first global multiplexer 120, a data multiplexer 304 coupled to the input/output sense amplifier 135, a data output buffer 402 coupled to the data multiplexer 304, and a data output driver 404 coupled to the data output buffer 402 and that drives output data.

The data input path circuit may include a data input buffer 406 coupled to a pad PAD1 of the first port 500, a first input driver 305 coupled to the data input buffer 406, and a second input driver 136 coupled to the first input driver 305 and the first global multiplexer 120.

Referring again to FIG. 8, multiple memory cells disposed in a matrix of rows and columns in the shared memory region 100 may be DRAM memory cells 4, each including an access transistor AT and a storage capacitor C.

In the first shared memory region 100 shown in FIGS. 7 and 8, two input/output sense amplifier and write drivers 130 and 131, and respective the first and second global multiplexers 120 and 121 may each switch data to different ports.

Referring to FIG. 8, the first and second processors 10 and 12 share the use of circuit devices and lines disposed between a global input/output line pair GIO, GIOB and a memory cell 4. The first and second processors 10 and 12 independently use input/output related circuit devices and lines disposed between the respective ports 500 and 510 and global multiplexers 120 and 121.

Specifically, the global input/output line pair GIO, GIOB of the shared memory region 100, local input/output line pair LIO, LIOB, bit line pair BLi, BLBi, bit line sense amplifier 5 and memory cell 4 are shared by the first and second processors 10 and 12 through the first and second ports 500 and 510, respectively. The local input/output line pair LIO, LIOB is coupled to the global input/output line pair. The bit line pair BLi, BLBi is coupled to the local input/output line pair by a column selection signal CSL. The bit line sense amplifier 5 is coupled to the bit line pair BLi, BLBi, and senses and amplifies data on bit line pair BLi, BLBi. The memory cell 4 is coupled to the bit line pair BLi, BLBi through an access transistor AT.

FIG. 9 is a circuit diagram illustrating in detail an embodiment of path deciding part 201 shown in FIGS. 7 and 8. Referring to FIG. 9, gating part 202 includes multiple logic gates, and receives row address strobe signals RASB_A and RASB_B, write enable signal WEB_A and WEB_B, and bank selection address BA_A and BA_B, respectively applied through the first and second ports 500 and 510. The gating part 202 generates gating signals PA and PB shown in a lower part of the drawing, For example, when the gating signal PA is output as a logic low level, the access selection signal PRB_MA is output as a logic low level. The gating signal PB is maintained as a logic high level, and the access selection signal PRB_MB is output as a logic high level.

If a single processor is accessing the DRAM 17 through a respective port, when the corresponding row address strobe signal RASB is input to the gating part 202, the appropriate access selection signal PRB_MA or PRB_MB is generated so that the first memory region 100 is accessed by the single processor. However, if two processors are attempting simultaneous accesses, the row address strobe signals RASB_A and RASB_B are applied through the respective ports simultaneously. A processor having a priority is allowed access to the first memory region 100 and the appropriate access selection signal PRB_MA or PRB_MB is generated.

Additionally, the path deciding part 201 of FIG. 9 includes inverters 203, 204, 212 and 213, NAND gates 205 and 206, delay devices 207 and 208, and NAND gates 209 and 211, with a wiring structure shown in FIG. 9. In such configuration, the access selection signal PRB_MA is provided as a given time delayed and latched signal of the gating signal PA, and the access selection signal PRB_MB is provided as a given time delayed and latched signal of the gating signal PB.

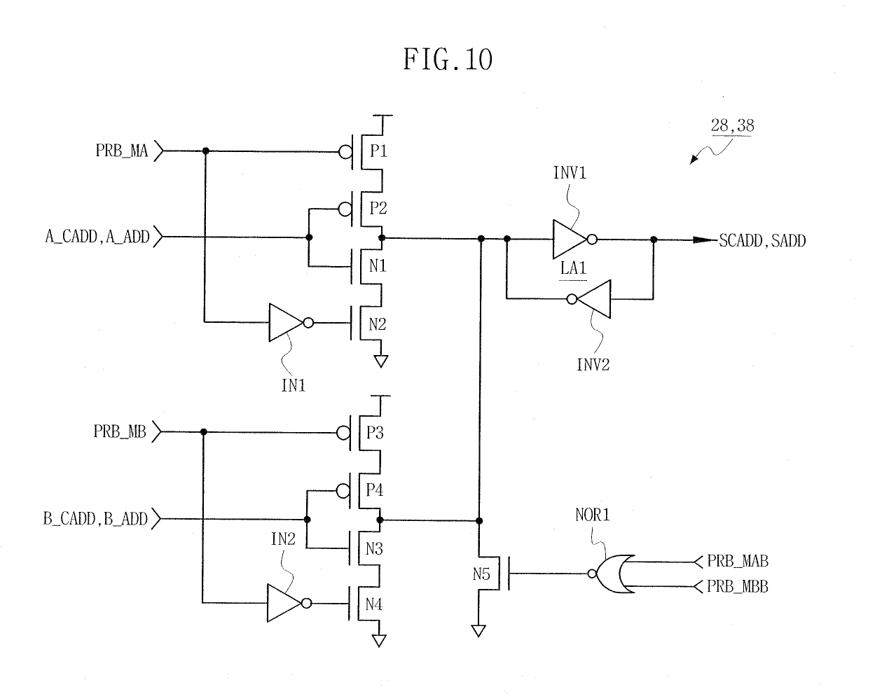

FIG. 10 is a circuit diagram illustrating in detail an address multiplexer such as a row address multiplexer 28 and column address multiplexer 38 as shown in FIGS. 7 and 8. Thus, the same address multiplexer circuitry may be used as a row address multiplexer or column address multiplexer as determined by the input signals used. A column address multiplexer 38 will be described with reference to the specific circuitry; however, the description applies equally to a row address multiplexer with appropriate signal changes.

Column address multiplexer 38 includes clocked CMOS inverters, including P-type and N-type MOS transistors P1-P4 and N1-N5, and an inverter latch LA1 including inverters INV1 and INV2. Two input terminals of the column address multiplexer 38 individually receive column addresses A_CADD and B_CADD through two ports. The column address multiplexer 38 selects one of two inputs by a logic state of the access selection signals PRB_MA and PRB_MB, and then outputs the selected address as a selected column address SCADD. An N-type MOS transistor N5 and a NOR gate NOR1 are arranged to form a discharge path between an input terminal of the inverter latch LA1 and a ground.

For example, the access selection signal PRB_MA is applied as a logic low level, column address A_CADD applied through a first port (port 500 or port A) is inverted through an inverter formed by P-type and N-type MOS transistors P2 and N1. The column address A_CADD is again inverted by an inverter INV1, and is output as a selected column address SCADD. The access selection signal PRB_MB is applied as a logic high level. As a result, the column address B_CADD, applied through a second port (510 or port B), is not supplied to an input terminal of the latch LA1 since the inverter formed by P-type and N-type MOS transistors P4 and N3 is not activated. Consequently, column address B_CADD, applied through second port, is not selected as selected column address SCADD.

When an output of the NOR gate NOR1 becomes a high level, the N-type MOS transistor N5 is turned on, and a logic level latched in the latch LA1 is reset to a low level.

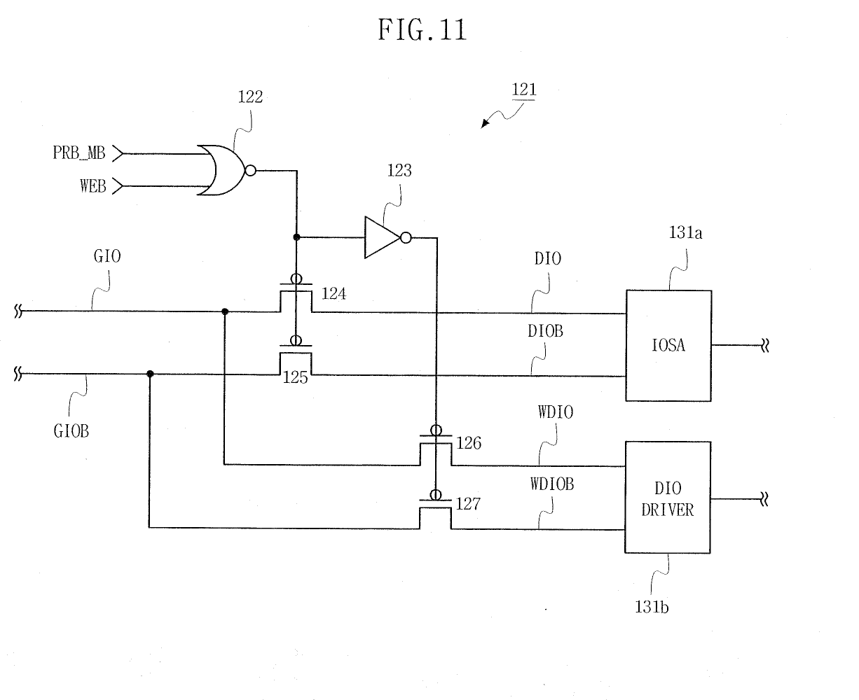

FIG. 11 is a circuit diagram illustrating in detail a second multiplexer 121 shown in FIGS. 7 and 8. With reference to the drawings, a NOR gate 122, an inverter 123 and four P-type MOS transistors 124-127 constitute the second multiplexer 121 coupled as shown in FIG. 11. The P-type MOS transistors 124 and 125 and the P-type MOS transistors 126 and 127 operate to selectively form one of a read path and a write path. For example, in a read operating mode, the P-type MOS transistors 124 and 125 are turned on, and the global input/output line pair GIO, GIOB and the data input/output line pair DIO, DIOB are coupled to each other. In a write operating mode, the P-type MOS transistors 126 and 127 are turned on, and the global input/output line pair GIO, GIOB and the write data input/output line pair WDIO, WDIOB are coupled to each other.

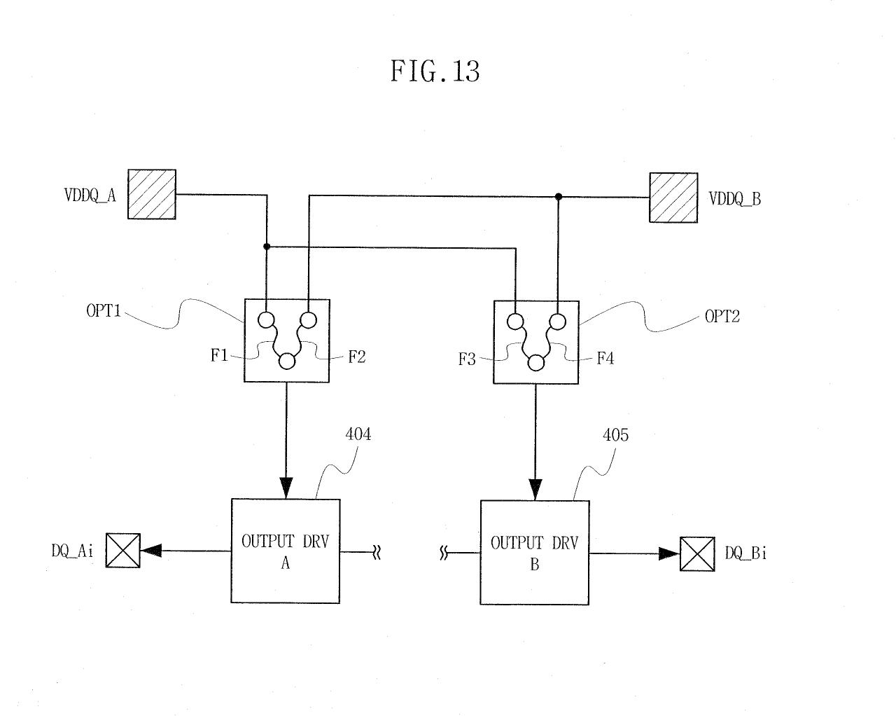

Referring to FIGS. 13 to 15, a method of applying an operating power source voltage of first port output driver 404 or second port output driver 405 shown in FIG. 12 in the same level or mutually different levels will be described as follows.

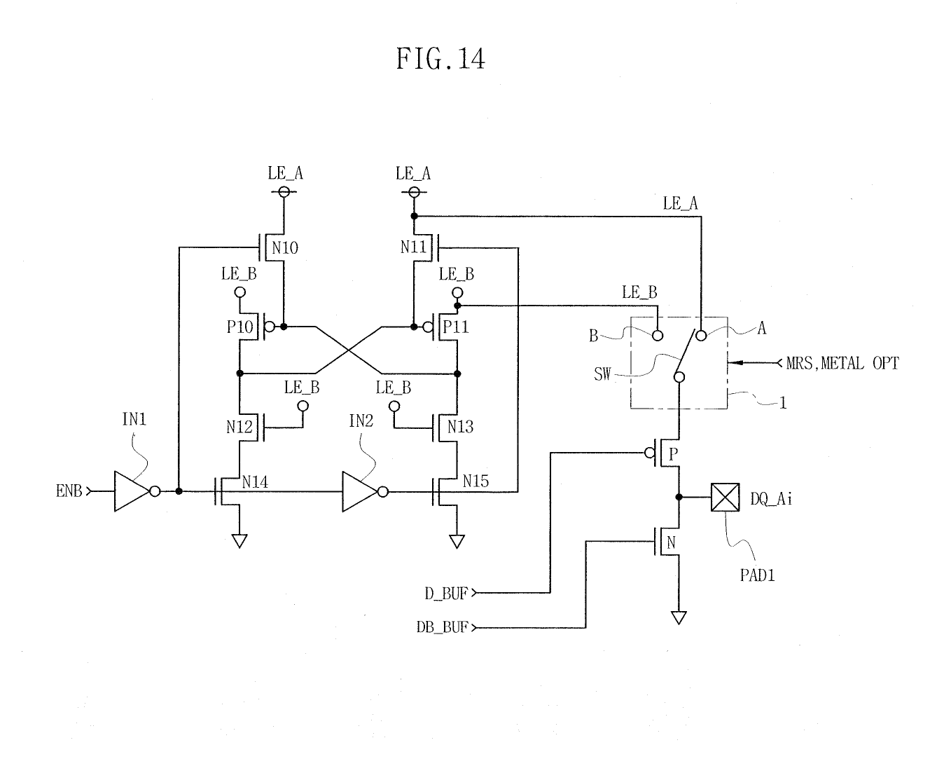

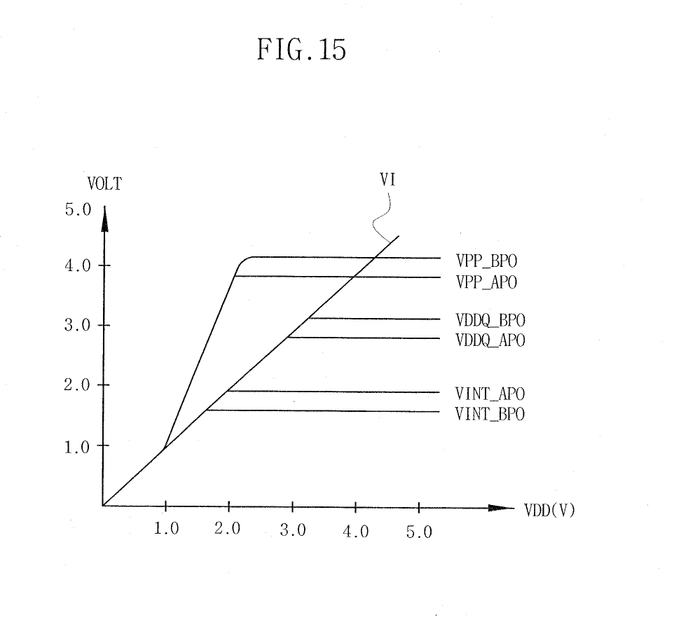

FIG. 13 is a block diagram illustrating a fuse option for a power source level selection per port according to some embodiments. FIG. 14 is a block diagram illustrating various control options for a power source level selection per port according to another embodiment. FIG. 15 is a graph for several levels of power sources applied per port in an embodiment of a DRAM 17.

With reference to FIG. 13, the first port output driver 404 and the second port output driver 405 may receive a first power source voltage level VDDQ_APO or second power source voltage level VDDQ_BPO, shown in FIG. 15 as operating voltage, by selectively laser cutting or current blowing fuses F1, F2, F3, F4 of first and second fuse option parts OPT1 and OPT2. For example, when a fuse F2 within the first fuse option part OPT1 is cut, the output driver 404 may receive a first power source voltage level applied through a terminal VDDQ_A. When a fuse F3 within the second fuse option part OPT2 is cut, the output driver 405 may receive a second power source voltage level applied through a terminal VDDQ_B. Consequently, the output driver 405 may drive data output in a higher level as compared with the output driver 404, and may provide it to an output terminal DQ_Bi. As a result, the second processor may have an advantage of being able to process data more smoothly.

FIG. 14 illustrates a scheme that a switch SW of option part 1 is switched to a terminal selected from first and second terminals A and B by applying a mode register set (MRS) command or extension mode register set (EMRS) command, or by a metal option in a manufacturing process. In the drawing, an inverter constructed of a P-type MOS transistor P and an N-type MOS transistor N is represented as an equivalent output driver, and the configuration of devices P10, P11, N10-N15, IN1 and IN2 indicates a well-known level shifter circuit. A data output driver according to an embodiment may drive output data as a first determined swing level by a fuse option or metal option. In addition, since the first determined swing level may be set separately from a second determined swing level, the first determined swing level may be lower than a second determined swing level of a data output driver installed within the second input/output related circuit.

In the following discussion, additional embodiments will be described according how to access to a shared memory region allocated within a memory cell array by multiple processors. Hereafter, the drawings related to the invention will be herein referred to as needed.

Referring back to FIG. 6, an operation of accessing by second processor 12 to a third memory region 102 as a private memory or fourth memory region 103 as a private memory through second port 510 is similar to a datan access operation of general DRAM. The access by first or second processor 10, 12 to the first or second memory region 100 or 101 provided as the shared memory region will be described.

Assuming that the first processor 10 accesses the first memory region 100 in a read operating mode, the path deciding part 201 of FIG. 9 logically combines external signals RASB_A, WEB_A and BA_A, and outputs a access selection signal PRB_MA as a logic low level, and a access selection signal PRB_MB as a logic high level. Thus, row address multiplexer 28 shown in FIG. 8 selects a row address A_ADD applied through first port A, and outputs it as a selected row address SADD. The row decoder 30 operates so that a word line WLi within the first memory region 100 to be accessed by the first processor 10 is activated. When the word line WLi is activated, data of memory cells that a gate of access transistor AT is connected to the activated word line WLi is developed on a corresponding bit line pair. For example, when the gate of access transistor AT constituting a memory cell 4 receives a voltage higher than an operating power source voltage by a word line boosting operation, potentials developed to bit line BLi appear according to a state of charge stored in a storage capacitor C. For example, the state may be 1.8 to 3 Volt in a charged state and 0 Volt in a non-charged state. In other words, charge sharing operations with bit line in the charging and non-charging state are represented different from each other, and the difference is sensed and amplified by bit line sense amplifier 5. For example, when a potential of bit line BLi is provided as a high level and a potential of bit line bar BLBi as a complementary bit line is provided as a low level, and when a column gate responding to a logic high level of column selection signal CSL is turned on, a potential of the bit line pair BLi, BLBi is transferred to a corresponding local input/output line pair LIO, LIOB as shown in FIG. 8.

The word line WLi is activated and data of memory cell appear as potential of high or low level on the bit line pair BLi, BLBi, and then the column address multiplexer 38 shown in FIG. 10 selects a column address A_CADD of first port A and outputs it as selected column address SADD. The column decoder 40 operates so that a potential of bit line pair BLi, BLBi within the first memory region 100 accessed by the first processor 10 is transferred to local input/output line pair LIO, LIOB.

Data of the local input/output line pair LIO, LIOB provided with a potential level is transferred to global input/output line pair GIO, GIOB when N-type MOS transistors 21 and 22, constituting a first multiplexer 20, LIO MUX, are turned on. A switching signal LIOC applied in common to gates of the transistors 21 and 22 may be a signal generated corresponding to a decoding signal output from the row decoder 30.

The above example is for the case that access selection signal PRB_MA is output as a logic low level. Thus, the data transferred to the global input/output line pair GIO, GIOB is transferred to an input/output sense amplifier and driver 130 through the second multiplexer 120. As shown in FIG. 12, an input/output sense amplifier 135 amplifies data that was weakened from being transferred through the paths, and transfers it to an output buffer 402 through a multiplexer and driver 300. An output driver 404 receiving data from the output buffer 402 drives the data in a voltage swing of first determined level VDDQ_A. Thus, the first processor 10 reads data stored in the memory cell 4 through the first port (500 of FIG. 7).

In the above example, the second multiplexer 121 is disabled. Thus an access operation of second processor 20 to the first memory region 100 is cut off. However, in this case, second processor 12 of FIG. 6 may still access memory regions 101, 102 and 103 thorough the second port 510. Furthermore, the determined size or number of the shared memory regions may be changed depending upon an operating load of the first and second processors.

In the following description, assuming that the second processor 10 accesses the first memory region 100 in a write operation, the path deciding part 201 logically combines external signals RASB_B, WEB_B and BA_B applied from second processor 12, and outputs a access selection signal PRB_MB in a logic low level and access selection signal PRB_MA in a logic high level. Thus, row address multiplexer 28 shown in FIG. 8 selects a row address B_ADD applied through second port B, and outputs it as selected row address SADD. Row decoder 30 operates so that word line WLi within the first memory region 100 to be accessed by the second processor 12 is activated. When the word line WLi is activated, access transistor AT of a memory cell is turned on and data applied through a column-selected bit line pair is ready for writing to be stored at a storage capacitor C.

On the other hand, write data applied through second port B is sequentially passed through an input buffer 410 and a driver 310 of FIG. 8, and is applied to a DIO driver 131b of FIG. 11. The DIO driver 131b again drives the applied write data, and then is transferred to a write data input/output line pair WDIO, WDIOB. A NOR gate 122 of FIG. 11 outputs a logic high level, then P-type MOS transistors 126 and 127 are turned on. The write data of the write data input/output line pair WDIO, WDIOB is transferred to the global input/output line pair GIO, GIOB.

At this time, the second multiplexer 120 of FIG. 8 is in a disabled state. When N-type MOS transistors 21 and 22, constituting first multiplexer 20, LIO MUX, are turned on, the write data of global input/output line pair GIO, GIOB is transferred to the local input/output line pair LIO, LIOB. At this time, a logic level of the column selection signal CSL has a high state and column gates T and T2 are turned on. Thus, data of local input/output line pair LIO, LIOB is transferred to a corresponding bit line pair BLi, BLBi, and is stored at a storage capacitor of the memory cell 4 through sense amplifier 5. Substantially simultaneously, the first processor 10 of FIG. 6 may access memory regions 101, 102 and 103 other than the first memory region 100.

As described above, in a semiconductor memory device according to some embodiments, a plurality of processors may smoothly access to a shared memory region within a memory cell array, thus a data transmission and processing speeds increase. In addition, a system size becomes compact, and the number of memories is reduced, lessening a cost of memory for the system. In employing the memory in a handheld electronic device, an operating performance is improved and a cost is substantially reduced.

Although one particular configuration of banks has been described, one skilled in the art will understand that any number and configuration of banks may be used. For example, a DRAM 17 may include 16 banks where 14 banks may be accessed by both a first processor and a second processor.

Furthermore, access is not limited to two processors and shared banks may be allocated as desired among the processors. For example, a DRAM 17 may include 8 banks. A first processor and a second processor may share banks 1-2. The second processor and a third processor may share banks 3-4. The third processor and a fourth processor may share bank 5. The first processor, the second processor, and the third processor may exclusively access banks 6, 7, and 8, respectively, while the fourth processor cannot access any exclusive bank.

For example, in four memory regions, one may be indicated as a shared memory region and the rest three may be indicated as private memory regions, or all of four memory regions may be determined as shared memory regions. In addition, the case for a dual processor was principally described above, but if three or more processors are employed in the system, three or more ports may be installed in one DRAM, and one of three processors may access to a determined shared-memory within a specific time. Further, other structure varied from the structure that a multiplexer as a path switch between an input/output sense amplifier and a global data line pair is installed may be provided so as to perform a path switching at another position.

Although a DRAM was described above, embodiments may include a static random access memory, nonvolatile memory, or other memory types.

Some embodiments provide a multi processor system capable of smoothly accessing a shared memory region allocated within a DRAM memory cell array.

Some embodiments provide a multi-path accessible semiconductor memory device that has a memory region shared by one or more processors within a memory cell array.

Some embodiments provide a multi-path accessible dynamic random access memory in which a memory region of a memory cell array can be accessed through mutually different paths, where the memory cell array has memory cells arrayed in a matrix type of rows and columns, and the memory cell includes one access transistor and one storage capacitor.

Some embodiments provide a circuit for controlling a read operation-related path of DRAM, which is capable of reading out data of memory cell selected from a DRAM memory cell array region through a path desired among two or more paths. In the circuit, data of memory cell selected from a DRAM memory cell array region can be read out through a port that may be accessed through two or more ports.

Some embodiments provide a circuit for controlling a write operation-related path of DRAM, which is capable of writing write data provided through one path selected from two or more paths, to a memory cell selected within a DRAM memory cell array region. In the circuit, write data provided through one port selected from two or more ports can be written to a DRAM memory cell selected from a DRAM memory cell array region.

Some embodiments provide a circuit for controlling an output level of DRAM, which is capable of independently operating swing levels of data output through multiple ports when independent two or more ports are installed within a DRAM.

Some embodiments provide a circuit for controlling a level of power source voltage of DRAM, which is capable of independently operating levels of array power source voltage by an accessed port when independent two or more ports are installed within a DRAM.

Some embodiments provide improved or new mobile oriented memory structures and methods, through which a read/write path control appropriate to a layout of private or/and shared memory regions and input/output sense amplifiers within a memory array and to respective ports can be realized resulting in a high data processing speed.

Some embodiments provide a multi-path accessible dynamic random access memory, by which a data transmission and processing speed can be improved and a system size can become compact, and a cost of memory within a system can be reduced.

A semiconductor memory device according to some embodiments includes at least one shared memory region allocated in a memory cell array, which is coupled with independently accessible ports corresponding to the number of processors. The shared memory region may be accessed selectively by the processors; and an access path forming part for forming a datan access path between one port selected from the ports and the shared memory region in response to external signals applied from the processors.

A semiconductor memory device according to some embodiments includes at least one shared memory region allocated in a memory cell array, which is coupled with independent first and second ports, and which is accessed selectively by first and second processors. The semiconductor memory device also includes an access path forming part for forming a datan access path in a determined swing level per port, between one port selected from the ports and the shared memory region, in response to external signals applied from the processors.

In some embodiments, the access path forming part may include a path deciding part for logically combining the external signals and generating an access selection signal; a row and column address multiplexer for selecting one row and column address among row and column addresses each applied through the first and second ports in response to the access selection signal, and for individually applying the address to a row decoder and a column decoder connected to the shared memory region; first and second global multiplexers for connecting between a global input/output line pair of the shared memory region and a first data input/output line pair or between the global input/output line pair of the shared memory region and a second data input/output line pair, in response to the access selection signal; and an input/output related path part including a first input/output related circuit installed between the first global multiplexer and the first port, and a second input/output related circuit installed between the second global multiplexer and the second port.

In some embodiments, the first input/output related circuit may include a data output path circuit and a data input path circuit. The data output path circuit may include an input/output sense amplifier operationally connected to the first global multiplexer, a data multiplexer operationally connected to the input/output sense amplifier, a data output buffer connected to the data multiplexer, and a data output driver that is connected to the data output buffer and that drives output data. The data input path circuit may include a data input buffer connected to the first port, a first input driver connected to the data input buffer, for primarily driving write data, and a second input driver connected to the first input driver, for secondarily driving the write data.

In some embodiments, multiple memory cells disposed in a matrix type of rows and columns in the shared memory region may be DRAM memory cells of which each includes an access transistor and a storage capacitor. Two input/output sense amplifiers may be disposed in one shared memory region.

In some embodiments, the first and second global multiplexers may have mutually contrary switching operations, and the path deciding part may generate the access selection signal by logically combining a row address strobe signal, a write enable signal and a bank selection address each applied through the first and second ports.

In some embodiments, the first and second processors may share, through the first and second ports, a global input/output line pair of the shared memory region, a local input/output line pair coupled to the global input/output line pair, a bit line pair coupled to the local input/output line pair through use of a column selection signal, a bit line sense amplifier adapted on the bit line pair, for sensing and amplifying data of bit line, and a memory cell connected to an access transistor, the memory cell being formed on the bit line pair.

In some embodiments, the data output driver 7 may drive the data in a first determined level by a fuse option or metal option. The first determined swing level may be different than a second determined swing level of data output driver installed within the second input/output related circuit.

In some embodiments, the data output driver may drive the data in a first determined swing level by an applied mode register set command or extended mode register set command.

When the first processor accesses to the shared memory region through the first port, the second processor may access to other memory regions other than the shared memory region accessed by the first processor through the second port. Two shared memory regions and two private memory regions may be allocated in a unit of bank to the memory cell array.

A portable communication system according to some embodiments includes a first processor for performing a first determined task; a second processor for performing a second determined task; and a dynamic random access memory, which includes a memory cell array having a first memory region accessed by the first and second processors, and a second memory region accessed only by the second processor, first and second ports each connected corresponding to buses of the first and second processors, and an access path forming part for forming a datan access path between one port selected in the ports and the first memory region in response to external signals applied from the first and second processors.

A method of controlling a datan access in a semiconductor memory device, according to some embodiments, includes preparing at least one shared memory region and at least two input/output ports independent from each other, within a memory cell array of the device; and operationally connecting a datan access path between one port selected from the ports and the shared memory region in response to applied external signals.

In the configuration of the invention described above, according to some embodiments, a shared memory region allocated within a memory cell array can be smoothly accessed by a plurality of processors. Thus a data transmission speed and processing speed is improved, and the size of system becomes compact. A cost of memory can be reduced by reducing the number of memories. Accordingly a more improved multi processor system is provided.

It will be apparent to those skilled in the art that modifications and variations can be made to the above-described embodiments without deviating from the spirit or scope as defined by the following claims. Thus, it is intended that the spirit and scope include any such modifications and variations and their equivalents.

1. A semiconductor memory device, comprising:
a plurality of ports;
a plurality of data line pairs, each port associated with one of the data line pairs;
a plurality of sets of address lines, each port associated with one of the sets of address lines;
a shared memory region of a memory cell array, the shared memory region accessible through the ports;
an access controller coupled to the ports and configured to generate an access selection signal in response to a plurality of control signals received through the ports; and
an access router coupled to the shared memory region, the data line pairs, and the sets of address lines, the access router configured to selectively couple one of the sets of address lines and one of the data line pairs to the shared memory region in response to the access selection signal.

2. The device of claim 1, wherein the access router comprises:
a row and column address multiplexer coupled to the sets of address lines and configured to select a row address and a column address from the sets of addresses for access to the shared memory region in response to the access selection signal; and
a plurality of global multiplexers coupled to a global input/output line pair of the shared memory region and the data line pairs, and configured to selectively couple the global input/output line pair to one of the data line pairs in response to the access selection signal.

3. The device of claim 2, wherein the global input/output line pair of the shared memory region is accessible through every port.

4. The device of claim 2, wherein the access controller is further configured to generate the access selection signal in response to row address strobe signals, write enable signals, and bank selection addresses received through the ports.

5. The device of claim 2, further comprising:
a plurality of input/output circuits, each input/output circuit coupled to an associated global multiplexer through an associated data line pair, and coupled to an associated port.

6. The device of claim 5, wherein each input/output circuit comprises:
a data output path circuit including:
an input/output sense amplifier coupled to the associated global multiplexer;
a data multiplexer coupled to the input/output sense amplifier;
a data output buffer coupled to the data multiplexer; and
a data output driver coupled to the data output buffer and the associated port; and
a data input path circuit including:
data input buffer coupled to the associated port;
a first input driver coupled to the data input buffer; and
a second input driver coupled to the first input driver and the associated global multiplexer.

7. The device of claim 6, wherein at least two input/output sense amplifiers of the input/output circuits are disposed in the shared memory region.

8. The device of claim 6, wherein for each data output driver, the data output driver is configured to drive the data at a swing level determined by at least one of an associated fuse option and an associated metal option.

9. The device of claim 6, wherein a swing level of at least one data output driver is different from a swing level of at least one other data output driver.

10. The device of claim 6, wherein for each data output driver, the data output driver is configured to drive the data at a swing level determined by at least one of a mode register set command and an extended mode register set command.

11. The device of claim 2, wherein the global multiplexers are configured such that at most one global multiplexer couples the associated data input/output line pair to the global input/output line pair at any one time.

12. The device of claim 1, further comprising:
a second shared memory region;
a plurality of second data line pairs; and
a second access router coupled to the second shared memory region, the second data line pairs, and the sets of address lines, the second access router configured to selectively couple one of the sets of address lines and one of the second data line pairs to the shared memory region in response to a second access selection signal;
wherein the access controller is further configured to generate the second access selection signal in response to the control signals received through the ports.

13. The device of claim 12, wherein the access controller is further configured to allow access to the first shared memory region through the first port and access to the second shared memory region through the second port substantially simultaneously.

14. The device of claim 1, further comprising a plurality of private memory regions, each private memory region accessible only though an associated port.

15. The device of claim 1, wherein the shared memory region further comprises a plurality of memory cells, each memory cell including an access transistor and a storage capacitor.

16. A method of operating a semiconductor memory device, comprising:
receiving a plurality of addresses through a plurality of ports, each address associated with an access operation through an associated port;
generating a access selection signal in response to a plurality of control signals received through the ports;
selecting an address from among the addresses for access to a shared memory region in response to the access selection signal;
forming a data input/output path between a port associated with the selected address and the shared memory region in response to the access selection signal; and
accessing data in the shared memory region through the data input/output path.

17. The method of claim 16, wherein:
selecting the address further comprises:
selecting a row address from the addresses in response to the access selection signal; and
selecting a column address from the addresses in response to the access selection signal; and
accessing the data in the shared memory region further comprises accessing the data in the shared memory region according to the selected row address and the selected column address.

18. The method of claim 16, wherein the shared memory region is referred to as a first shared memory region, the method further comprising:
accessing data in a second shared memory region of the memory cell array through a second port substantially simultaneously as accessing the data in the first shared memory region.

19. The method of claim 16, further comprising:
accessing data in a private memory region of the memory cell array through a second port substantially simultaneously as accessing the data in the shared memory region.

20. The method of claim 16, further comprising:
selecting an output drive level for an output driver of a port, wherein the output drive level is different from at least one output drive level of the other ports.

21. The method of claim 16, wherein forming the data input/output path further comprises:
selecting a data input/output line pair from a plurality of data input/output line pairs associated with the ports in response to the access selection signal; and
coupling a global input/output line pair of the shared memory region with the selected data input/output line pair.

22. A semiconductor memory device, comprising:
at least one shared memory region of a memory cell array, each shared memory region accessible through an associated plurality of ports;
for each shared memory region:
an access controller coupled to the ports associated with the shared memory region and configured to generate a access selection signal in response to a plurality of control signals received through the associated ports, the access selection signal indicating a selected port that is granted access to the shared memory region;
a plurality of data line pairs, each port associated with one of the data line pairs;
a plurality of sets of address lines, each port associated with one of the sets of address lines;
a plurality of global multiplexers coupled to a global input/output line pair of the shared memory region and the data line pairs, and configured to selectively couple the global input/output line pair to a data line pair associated with the selected port in response to the access selection signal;
an address decoder coupled to column select lines and word lines of the shared memory region; and
an address multiplexer coupled to the sets of address lines and an the address decoder, the address multiplexer configured to route an address on a set of address lines associated with the selected port to the address decoder in response to the access selection signal; and
for each port:
at least one input/output sense amplifier and driver coupled to the associated data lines;
a multiplexer and driver coupled to the input/output sense amplifier and driver; and
an input/output buffer coupled to the multiplexer and driver, and coupled to the port.

23. The semiconductor memory device of claim 22, wherein:
each address decoder further comprises a column decoder and a row decoder; and
each address multiplexer further comprises:
a column address multiplexer coupled to the column decoder of the associated address decoder, coupled to column address lines of the associated sets of address lines, and configured to route a column address to the column decoder in response to the access selection signal; and
a row address multiplexer coupled to the row decoder of the associated address decoder, coupled to row address lines of the associated sets of address lines, and configured to route a row address to the row decoder in response to the access selection signal.

24. The semiconductor memory device of claim 22, further comprising:
at least one private memory region accessible through only one of the ports;
for each private memory region:
a global multiplexer coupled to a global input/output line pair of the private memory region and a data line pair; and
an input/output sense amplifier and driver coupled to the data line pair and one of the multiplexer and drivers associated with the port.

25. The semiconductor memory device of claim 24, wherein for at least one private memory region:
the input/output sense amplifier and driver is one of the input/output sense amplifiers coupled to a shared memory region accessible through the port associated with the private memory region.

26. The semiconductor memory device of claim 22, wherein:
for at least one port, at least one input/output sense amplifier and driver is coupled to a plurality of the shared memory regions through the data lines associated with both the port and the shared memory regions associated with the port.
